(19) United States
(12) Patent Application Publication
(10) Pub. No.: US 2009/0223632 A1
(43) Pub. Date: Sep. 10, 2009

(54) ABRADABLE MATERIAL COMPOSITION, A THERMOMECHANICAL PART OR CASING INCLUDING A COATING, AND A METHOD OF FABRICATING OR REPAIRING A COATING PRESENTING SAID COMPOSITION

(75) Inventors: Philippe Charles,Alain Le Biez, Draveil (FR); Claude Marcel Mons, Savigny Le Temple (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SNECMA, Paris (FR)

(21) Appl. No.: 12/464,678

(22) Filed: May 12, 2009

Related U.S. Application Data
(62) Division of application No. 11/476,845, filed on Jun. 29, 2006.

(30) Foreign Application Priority Data
Jun. 30, 2005 (FR) 05 06736

(51) Int. Cl. B32B 37/12; C08K 7/26; B05D 1/36; C08K 7/24; C08L 83/06

(52) U.S. Cl. 156/329; 523/218; 427/409

(57) ABSTRACT

The invention relates to an abradable material composition comprising a resin-based matrix, in particular a silicone matrix together with filler comprising hollow beads. In characteristic manner, the hollow beads withstand high temperatures and are made of refractory material. The hollow beads are preferably made of an alumino-silicate material. The composition is applicable to making abradable coverings for compressor casings, in particular casings for compressors of the low pressure type or of the booster type, or for a fan, the covering being in register with moving blades.

### CROSS-REFERENCE TO RELATED APPLICATIONS

This application is a Divisional of and claims the benefit of priority under 35 U.S.C. § 120 from U.S. Ser. No. 11/476,845, filed Jun. 29, 2006, the entire contents of which are incorporated herein by reference and claims the benefit of priority from French application 05 06736 filed Jun. 30, 2005.

The invention relates to an abradable material composition (or a material that can be machined by moving parts), to a thermomechanical part (such as a casing) comprising a metal substrate covered in a wear portion comprising a covering presenting such a composition, and to a turbomachine fitted with such a thermomechanical part.

The invention also relates to a method of fabricating or repairing an abradable covering on a metal substrate and presenting such a composition.

### BACKGROUND OF THE INVENTION

In turbine engine applications, for portions that are said to be “cold”, i.e. for which the operating temperature does not exceed 250° C., there are to be found wear portions made of an abradable material composition comprising resin.

That type of abradable material is generally constituted by a matrix of hot-polymerizable resin, in particular a silicone resin, and a filler of hollow glass beads, for example.

Hollow glass beads are microspheres serving firstly to reduce the density of the covering composition, and secondly to contribute to the ability of the abradable material to be abraded.

The use of silicone resins has replaced the earlier use of organic resins which present insufficient mechanical strength, and, on being abraded, give rise to powder that, on combustion, creates residues that deflagrate at high temperatures and under high pressures.

Nowadays, new-generation turbine engines have hollow blades in their high pressure turbines that present perforations for ventilation or cooling channels connecting an internal cooling passage to the outside of the blade via ever-smaller diameters.

Those small perforations or small-diameter channels thus tends to become clogged easily and to be difficult to clear with ventilation pressure differences, thereby leading to local interruption of ventilation for the moving blades of the turbine, and thus to potentially major operating problems due to high temperatures, and possibly endangering the ability of the blades to maintain mechanical strength, or indeed leading to local melting.

At operating temperatures and in the event of a large amount of particles being given off during contact between the moving part and the abradable portion, it has been found that the use of hollow glass beads in abradable portions situated in particular upstream from the high pressure turbine, e.g. in the low pressure compressor, can lead to said material melting as it passes through the high pressure compressor, with the material then clogging the openings of the ventilation perforations in permanent manner.

### OBJECTS AND SUMMARY OF THE INVENTION

An object of the present invention is to provide an abradable material composition for which the wear debris is capable of withstanding high temperatures, and a method of obtaining a part covered in said material whose wear debris can withstand temperatures that are higher than those that can be withstood by presently-proposed compositions.

A particular object of the present invention is to overcome the drawbacks of prior art abradable materials in order to avoid permanently clogging ventilation perforations or cooling channels of small size due to hollow glass beads melting.

To this end, according to the present invention, the hollow beads are made of refractory material, glass being excluded, so that said beads present greater resistance to high temperatures.

It can thus be understood that by using refractory hollow beads that present a melting temperature that is much higher than that of glass beads, the problem of the hollow beads melting is avoided and they remain solid at the temperatures to which they are subjected, even in the hottest part of the turbomachine.

This solution also presents the additional advantage of making it possible to use hollow beads that are less expensive than glass beads, particularly if the hollow beads are combustion residues from fossil fuel power stations or steelworks, in particular if they are constituted by blast furnace slag.

Overall, by means of the solution of the present invention, it is possible to improve the high temperature behavior of the wear debris from abradable materials, and in particular it is possible to avoid the abrasion residues formed from the hollow beads melting in the hottest portions of turbojets.

In a preferred embodiment, the refractory material comprises alumina and/or silica and/or zirconia, and the refractory material preferably belongs to the family constituted by alumino-silicate materials.

Advantageously, said refractory material presents a melting temperature greater than 700° C., preferably greater than 750° C., and more preferably greater than 900° C.

The present invention also provides a thermomechanical part comprising a metal substrate covered in a wear portion comprising a covering presenting the above-defined composition and a bonding primer layer comprising silicone.

Advantageously, the substrate is made of titanium, steel, aluminum, or an alloy of any one of said metals.

In another advantageous disposition, the primer layer is colored.

Such a thermomechanical part is intended in particular for forming a wear portion of a sealing labyrinth, associated with wipers, in particular for a booster.

Such a thermomechanical part may also form part of a compressor casing, in particular for a low pressure compressor, and in particular of the booster type, or for a fan, in which the face of the wall that faces the moving blades has an abradable covering presenting the above-defined composition.

The present invention also provides a turbomachine including such a casing or a thermomechanical part as defined above.

Finally, the present invention also provides a method of fabricating or repairing an abradable covering on a metallic substrate, wherein the following steps are performed:

a) preparing a composition as defined above; and

b) applying said composition on said metal substrate to form said covering.

In a first variant of the method, the application step b) is performed by direct injection.

In a second variant of the method, application step b) comprises the following substeps:

b1) providing at least one pre-molded element presenting the composition as defined above (e.g. a strip, a ring, or a ring portion, . . . );

b2) depositing adhesive on the metal substrate and/or on said pre-molded element; and

b3) depositing said element on the substrate and holding said element firmly against the substrate while the adhesive sets.

Advantageously, the adhesive comprises hot-polymerizable silicone resin.

In addition, and preferably, a step is performed prior to step a) in which a bonding primer layer is applied to the substrate, the primer layer comprising silicone, said layer being optionally colored.

### BRIEF DESCRIPTION OF THE DRAWING

Other advantages and characteristics of the invention appear on reading the following description made by way of example and with reference to the accompanying drawing, in which:

FIG. 1 is a fragmentary half-section view of the front portion of a turbojet, with the fan and a low pressure compressor fitted with a casing.

### MORE DETAILED DESCRIPTION

Given that the present invention relates to abradable material compositions, in particular for abradable elements in a turbojet, the description below relates to one possible and non-limiting application of this composition in accordance with the present invention.

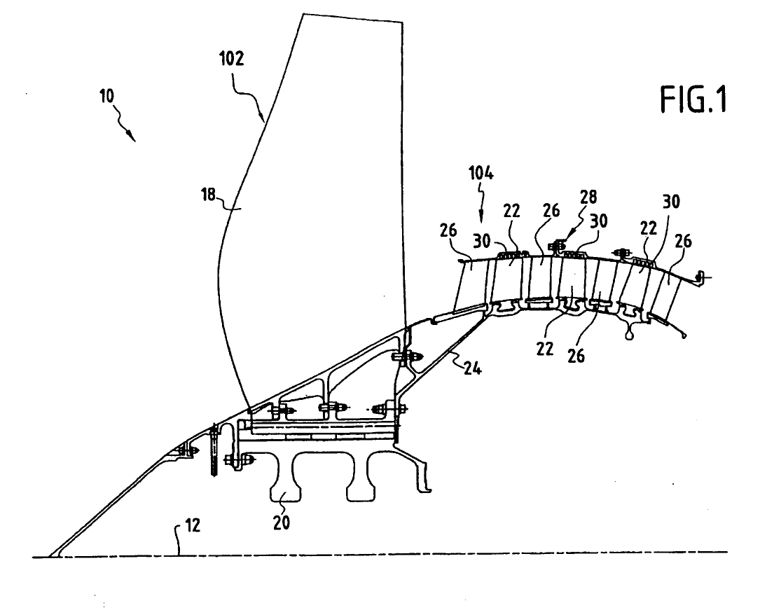

FIG. 1 is a section view showing half of the front portion 10 of a turbojet on one side of a longitudinal axis 12 constituting the axis of circular symmetry of the various elements of the turbojet, and in particular of its various moving elements.

In FIG. 1, there can be seen more precisely, amongst the various elements disposed axially around the longitudinal axis 12 and forming the conventional structure for such a turbojet, the fan 102 and the compressor 104 that operates at low pressure.

The fan 102 comprises a series of blades 18 projecting radially and mounted on an annular disk 20, the assembly being mounted to rotate about the longitudinal axis 12 of the turbojet.

In FIG. 1, the air flow direction determines an upstream portion (to the left in FIG. 1) and a downstream portion (to the right in FIG. 1).

The compressor 104 comprises a plurality of sets of rotary moving blades 22 mounted on a disk or drum 24 that is secured to the disk 20 of the fan 102.

In FIG. 1, there can be seen three sets of moving blades 22 mounted between five sets of stationary vanes 26 mounted on a casing 28.

The structure of the casing 28 is such that it includes rings 30 of abradable material on its inside face in register with the ends of the moving blades 22.

Amongst other applications of the abradable material of the present invention, mention can be made in particular of various circumstances in which the abradable elements are used in sealing labyrinths and are placed facing wipers.

According to the invention, these rings of abradable material present a composition based on silicone resin having hollow beads that are made of refractory material, not of glass.

By way of example, the hollow beads can be blast furnace residues constituted by coke slag. That type of material has the particular advantage of being inexpensive and of presenting grains that are sufficiently small in size.

Thus, it is advantageous to use hollow alumino-silicate beads of the type sold under the trade name Sovitec T212, that product being in the form of a very fine powder that is gray in color. 90% of the beads present a size that is less than 212 micrometers (pm). Those beads present an apparent density at 20° C. lying in the range 0.37 kilograms per cubic decimeter (kg/dm³) to 0.45 kg/dm³.

That product presents the following chemical composition (in % by weight):

| SiO₂ | 55% to 70% |
|---|---|
| Al₂O₃ | 20% to 40% |
| Fe₂O₃ | ≦10% |
| CaO | ≦4% |
| K₂O—NaO₂ | ≦8% |
| MgO | ≦5% |

It is also possible to use other refractory materials for the hollow beads, e.g. silica, alumina, zirconia, . . . .

A silicone resin or a mixture of silicone resins is used that presents viscosity making the resin suitable for being applied directly onto the substrate or for being applied thereto by injection.

The composition is thus the result of mixing together said silicone resin (a resin that is vulcanizable at high temperature), a catalyst, and the above-described hollow beads, said beads representing a percentage by weight lying in the range 10% to 25%, and preferably in the range 13% to 20% of the composition.

Before making the mixture, it should be observed that the hollow beads are preferably dried by being placed in a drying oven at 150° C. for at least one hour.

In order to facilitate bonding the abradable material on the substrate, which is generally made of titanium, steel, or aluminum, it is preferable to begin by applying a bonding primer layer on the substrate, the primer layer comprising silicone in a solvent.

The primer layer is applied with a brush, a spray gun, or a rag.

Advantageously, a colored primer is used, e.g. Dows Corning 1200 primer which is red in color.

In this way, it can be seen where the primer layer has already been deposited, so as to ensure that certain portions of the surface are not forgotten and also to avoid applying too much primer in other locations.

In a first variant technique for applying the composition, the composition is injected under pressure directly onto those locations of the substrate in question that are covered in the primer layer.

In a second variant technique for applying the composition, said composition is initially made in the form of a pre-molded element, which element may be a strip, a ring, or a ring portion, or any other element of a shape that is suitable for matching the location of the substrate that is to be covered in abradable material. Thereafter, said pre-molded element(s) is/are stuck onto the metal substrate (preferably using an adhesive made of the same type of silicone resin), and the parts are held in place for the time required for the adhesive to set, which is achieved by raising it to high temperature.

With both application techniques, once the composition has been applied by injection (first technique) or after molding one or more pre-molded elements (second technique), a polymerization cycle is performed at a temperature and for a duration that are sufficient to obtain the desired degree of hardening.

Thereafter, if necessary, the abradable coating thus formed on the metal substrate can be machined so as to have the design dimensions.

This composition in accordance with the invention can be used for fabricating rings or elements of abradable material, and also for repairing a metal thermomechanical part forming a substrate on which said abradable element constitutes the wear portion.

Such repair can relate to replacing an entire wear part or merely to locally retouching a damaged position, since the resin can be applied very easily to zones of small or large extent.

For localized repairs, it is possible to apply the composition like putty, using a tool such as a spatula.

What is claimed is:

1. A composition of abradable material comprising a matrix based on resin, in particular silicone resin, and filler comprising hollow beads, wherein the hollow beads are made of refractory material, glass being excluded.

2. A composition according to claim 1, wherein the refractory material comprises alumina and/or silica and/or zirconia.

3. A composition according to claim 1, wherein the refractory material belongs to the family constituted by alumino-silicate materials.

4. A composition according to claim 1, wherein said refractory material presents a melting temperature greater than 700° C., preferably greater than 750° C.

5. A method of fabricating or repairing an abradable covering on a metal substrate, wherein the following steps are performed:
a) preparing a composition according to claim 1; and
b) applying said composition on said metal substrate in order to form said covering.

6. A method according to claim 5, wherein application step b) is performed by direct injection.

7. A method according to claim 5, wherein application step b) comprises the following substeps:
b1) providing at least one pre-molded element presenting the composition according to claim 1;
b2) depositing adhesive on the metal substrate and/or on said pre-molded element; and
b3) depositing said element on the substrate and holding said element firmly against the substrate while the adhesive sets.

8. A method according to claim 7, wherein the adhesive comprises hot-polymerizable silicone resin.

9. A method according to claim 5, wherein an additional step is performed prior to step a) in which a bonding primer layer is applied to the substrate, the primer layer comprising silicone.
